(19) United States
(12) Patent Application Publication
(10) Pub. No.: US 2006/0081027 A1
(43) Pub. Date: Apr. 20, 2006

(54) Pet waste disposal assembly and method

(76) Inventor: Steven E. Rhodes, West Linn, OR (US)

Correspondence Address: Timothy E. Siegel;Suite 206, 1868 Knapps Alley, West Linn, OR, 97068-4644, US

(21) Appl. No.: 11/293,345

(22) Filed: Dec. 2, 2005

Related U.S. Application Data
(63) Continuation-in-part of application No. 10/824,308, filed on Apr. 14, 2004.
Application No. 10/824,308 is a continuation of application No. 10/253,554, filed on Sep. 24, 2002, now Pat. No. 6,758,880.

(51) Int. Cl. C05F 1/00; C05F 11/00

(52) U.S. Cl. 71/11; 71/15; 435/290.1; 435/290.2

(57) ABSTRACT

A method of disposing and treating a biodegradable material that produces an unpleasant odor when it is watered and stirred. The method makes use of an assembly having a container, a standard garden hose in fluid communication with a faucet, a pressure nozzle in fluid communication with the standard garden hose and a nozzle-retaining apparatus oriented so that the water expressed from the nozzle is directed into the container so as to produce a stirring motion within the container. The biodegradable material is placed into the container and the faucet is actuated to cause water to flow through the hose and out the nozzle. This waters and stirs the biodegradable material while the person performing the method remains at a distance far enough away from the container to avoid the unpleasant odor that is emitted from the container by virtue of the watering and stirring.

### RELATED APPLICATIONS

This application is a continuation-in-part of U.S. application Ser. No. 10/824,308 filed Apr. 14, 2004, which is a continuation of U.S. application Ser. No. 10/253,554 which was filed Sep. 24, 2002.

### BACKGROUND OF THE INVENTION

Pet waste, or more specifically, pet fecal matter, is a problem and an ever-increasing one. Exposure to pet waste, in its worst case, can cause minor ill health and numerous, sometimes serious diseases. The offensive odor of pet waste alone makes it more than a mere nuisance. Disposing of pet waste in a manner that is both responsible and economical requires a solution.

Today, the generally accepted method of disposal of pet waste, particularly in high-density or urban areas, is to wrap pet waste in plastic and deposit it in a municipal garbage can. This practice however, can pose health hazards. In some population areas, pet owners are required to dispose of pet waste in a manner so as to avoid posing a health hazard. Trash Haulers and Recycling Technicians are of particular concern. As the value of recycling increases, and as trash and recycling companies continue to increase the number of people hired to separate recyclable products from general rubbish, the concern for health in these areas will continue to grow as well. Also, a growing number of unauthorized individuals—the homeless, for example—who sift through trash cans looking to recover valuable items can also be exposed to this type of health hazard.

It should be understood that canine waste specifically is the primary concern due to the nature of its content, predominantly meat products which are particularly offensive in decaying form, and due to the sheer volume of material produced collectively by large numbers of dogs. Pet waste, in all of its forms from all types of pets, however, is of similar concern.

As with large municipal sewage treatment plants, the addition of water to facilitate and accelerate the breakdown is quite necessary. The process of mixing pet waste with water, and the churning action necessary to accelerate the breakdown of the combined material, however, can quickly produce offensive, noxious, and sometimes overwhelming odors. It can be a very unpleasant task for a user to remain near the pet waste as this process is taking place.

Stationary devices that treat waste eventually fill up past the point at which they remain effective. There are several reasons they do so: 1) they contain an over-abundance of non-biodegradable material, such as rocks, twigs, etc. that is added inadvertently, and 2) the residue of decayed mass accumulates past the point at which the soil can sufficiently absorb additional material. The end result requires the user to either remove the contents manually or abandon the unit and acquire another for the same purpose. The options are time-consuming and costly.

There exist today several pet waste disposal systems that allow the treatment of pet waste by the pet owners or pet caregivers. Of those, some incorporate the soil to bury pet waste and utilize the natural breakdown and decay process(es) found in common soil. Those same systems advocate the addition of chemicals to assist the decay process. Only one recommends the addition of water but does not give the operator a convenient way to do so, nor does it allow the advantage of doing so from a sufficient distance away from the unit so as to avoid offensive odors. None use the force of water as a means to churn, mix, and fragment waste.

### SUMMARY OF THE INVENTION

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

In a first separate aspect, the present invention may take the form of a method of disposing and treating a biodegradable material that produces an unpleasant odor when it is watered and stirred. The method makes use of an assembly having a container, a standard garden hose in fluid communication with a faucet, a pressure nozzle in fluid communication with the standard garden hose and a nozzle-retaining apparatus oriented so that the water expressed from the nozzle is directed into the container so as to produce a stirring motion within the container. The biodegradable material is placed into the container and the faucet is actuated to cause water to flow through the hose and out the nozzle. This waters and stirs the biodegradable material while the person performing the method remains at a distance far enough away from the container to avoid the unpleasant odor that is emitted from the container by virtue of the watering and stirring.

In a second separate aspect, the present invention may take the form of an assembly adapted to facilitate the disposing and treating of a biodegradable material that produces an unpleasant odor when it is watered and stirred. The assembly includes a container, a fitting for accepting and retaining the insertive coupler of a standard garden hose, a pressure nozzle in fluid communication with the fitting for receiving water from the fitting and expressing the water under pressure and a nozzle retaining apparatus oriented so that the water expressed from the nozzle is directed into the container so as to produce a stirring motion within the container.

In a third separate aspect, the present invention may take the form of a method of disposing and treating a biodegradable material that produces an unpleasant odor when it is watered and stirred. The method makes use of an assembly having a container, a nozzle-retaining apparatus oriented so that the water expressed from the nozzle is directed into the container so as to produce a stirring motion within the container. A hose having one end that is nozzle-bearing and another end that is connected to a faucet has its nozzle-bearing end placed into the nozzle-retaining apparatus. The biodegradable material is placed into the container and the faucet is actuated to cause water to flow through the hose and out the nozzle, thereby watering and stirring the biodegradable material while the person performing the method remains at a distance far enough away from the container to avoid the unpleasant odor that is emitted from the container by virtue of the watering and stirring.

In addition to the exemplary aspects and embodiments described above, further aspects and embodiments will become apparent by reference to the drawings and by study of the following detailed descriptions.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 shows a perspective view of a pet waste disposal assembly according to the present invention.

FIG. 2 shows an enlarged cross-sectional view of the nozzle illustrated in FIG. 1.

FIG. 3 shows an exploded isometric view of an alternative preferred embodiment of the present invention, having a round body, a detachable lid, and a water introduction system centrally mounted in the lid.

FIG. 4 shows a cross-sectional view of the pet waste disposal assembly of FIG. 1, partially buried in the ground in an idle state.

FIG. 5 shows a cross-sectional view of the pet waste disposal assembly of FIG. 1, partially buried in the ground and showing the watering and stirring of the pet waste.

FIG. 6 shows a cross-sectional view of the pet waste disposal assembly of FIG. 1, being pulled from the ground.

FIG. 7 shows an exploded isometric view of an additional alternative embodiment of a pet waste disposal assembly according to the present invention, having a water introduction located within the body, in a closed, non-operational state.

FIG. 8 shows an exploded isometric cut away view of the pet waste disposal assembly shown in FIG. 7 with the lid off, showing the water introduction system running longitudinally along the body of the invention.

FIG. 9 shows a perspective view of an alternative preferred embodiment of a solid waste disposal system, adapted to accept a nozzle-bearing hose.

FIG. 10 is a side sectional view of the disposal system of FIG. 9, showing a nozzle-bearing hose inserted into the system.

### DETAILED DESCRIPTION OF THE PREFERRED EMBODIMENTS

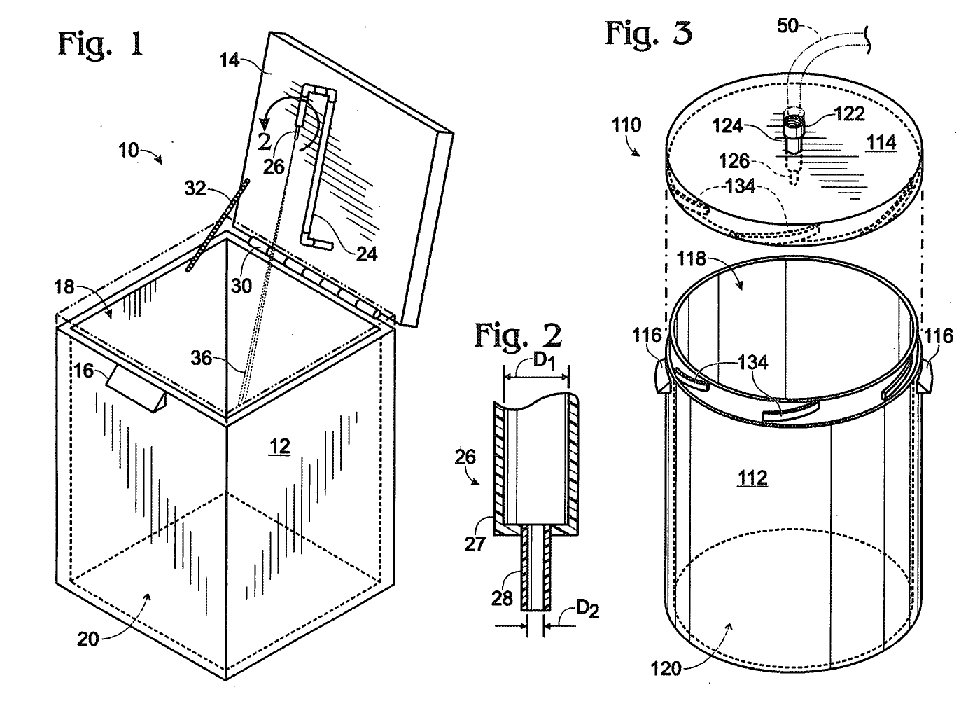

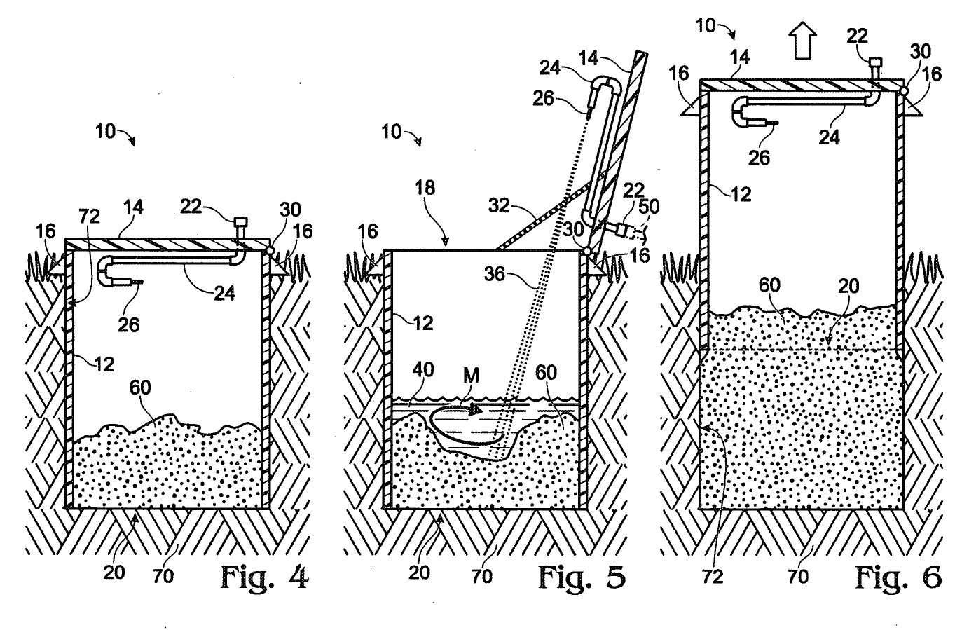

Referring to FIGS. 1, 2, 4, 5 and 6 a preferred embodiment of the pet waste treatment assembly 10 includes a body 12 that is in the form of a tube, having a top opening 18 and a bottom opening 20. A lid 14 is attached to body 12 by a hinge 30. A standard garden hose receptive fitting 22 (FIG. 5) permits the attachment of a standard garden hose 50. In turn, fitting 22 is attached to a length of tubing 24, which is attached to a nozzle 26. In another preferred embodiment, the tubing 24 may be incorporated and integrated into the lid 14 of the unit sufficient to render the piping assembly and the lid as one piece in whole. As shown in FIG. 4, body 12 may be partially buried in the ground 70 and partially filled with pet waste 60.

Referring now specifically to FIG. 2, nozzle 26 has a first section 27 having a first diameter D1 and a second section 28 having a second diameter D₂. Water speeds up through section D₂, as water must flow through section 28 at the same rate that it flows through section 27, requiring a higher rate of travel due to the smaller area available for fluid flow.

In order to facilitate the biological decomposition of the pet waste 60 it is advisable to periodically water and stir the pet waste 60. Unfortunately, this has heretofore been an unpleasant task for a human operator to perform, because this process produces an unpleasant odor. Using the assembly 10, however, an operator may attach the insertive coupler of a garden hose 50 to fitting 22 while lid 14 is closed. The operator may then open the lid, thereby positioning and orienting nozzle 26 so that it is directed at the waste 60. At this point the operator may add a chemical catalyst onto pet waste 60 to facilitate its decomposition.

After moving away from assembly 10 and to a faucet (not shown) to which the receptive coupler of the garden hose 50 is attached, the operator actuates the faucet, causing a water jet stream 36 to shoot from nozzle 26, thereby churning the waste 60 and creating a pool of water 40 and liquefied pet waste. Once the water 40 reaches a sufficient level without overflowing the unit, the faucet is turned off and the water gradually seeps through the pet waste and leaches through the bottom opening 20 and into the soil/earth 70 thereby continuing to facilitate the natural decay process of the pet waste 60. The operator may then wait until the unpleasant odor has abated before venturing to the assembly 10 to shut lid 14.

Skilled persons will recognize that the method described above successfully addresses the treatment of pet waste using water, the force of water, and organic activity as the means by which pet waste is successfully treated and ecologically disposed of, and does so in manner which allows pet owners to manage this process onsite, thereby avoiding municipal garbage systems altogether.

The importance of water as a medium to facilitate the break down of pet waste is paramount to successful treatment. In the method described above, the addition of water helps to: fragment large pieces of waste; loosen waste material to maximize the effectiveness of microbes to digest the material; aid in the even distribution of chemicals added in addition to water; and transport and distribute waste material in liquid form into the surrounding soil. A great advantage of this method is that it permits the operator to maintain the waste treatment assembly in one location for a comparatively long period of time. Without the frequent addition of water and chemicals, because the decomposition would not be accelerated, it would be necessary for the operator to move the assembly much more frequently.

After a period of use, body 12 may become almost entirely filled with pet waste 60. At this point, handles 16 may be used to pull body 12 out of the ground 72, leaving behind pet waste 60 and detritus, such as small twigs and leaves that are typically inadvertently collected together with pet waste. At this point the pet waste and the detritus have mixed together and have largely decomposed. The waste may now be covered with soil and allowed to further decompose, thereby providing a rich subsurface.

Referring to FIG. 3, an alternative preferred embodiment 110 has a body 112 in the form of a round tube, a shape that is generally less expensive to produce. A round lid 114 is fitted to body 112 by way of a set of diagonal, matching tabs 134, on body 112 and lid 114. A hose coupler receiving fitting 122 is oriented in tandem with tubing 124 and nozzle 126 so that water may be injected when the lid 114 is closed. One advantage of this embodiment is that the lid need not be raised in preparation for or after watering and stirring the pet waste.

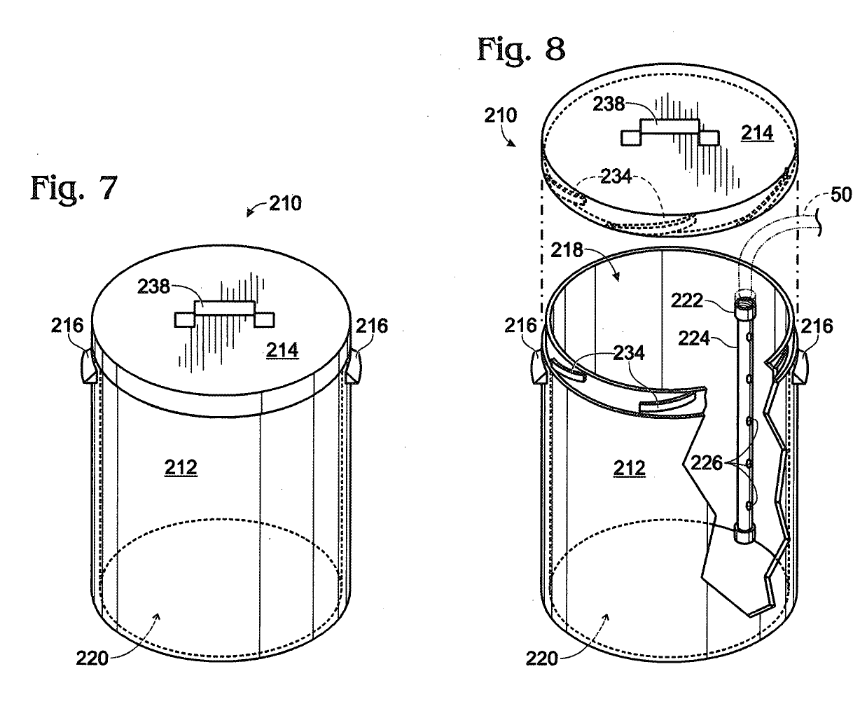

Referring to FIGS. 7 and 8, in an additional alternative preferred embodiment, water is injected into the assembly 210 by way of a set of side nozzles 226 from a tube 224 extending along the interior side of a tubular body 212. Although a receptive fitting 222 for attachment of a standard garden hose is shown in the interior of body 212, in a variant of this embodiment, the fitting 222 extends through an aperture in the side of 212 so that a garden hose may be connected to it while the lid 214 is shut. In another embodiment, the piping assembly 224 may be incorporated and integrated into the body of the unit 212 sufficient to render the piping assembly and the body as one piece in whole. Also, in the embodiment of FIGS. 7 and 8, the absence of a fitting, such as fitting 122, at the center of lid 214 permits a handle 238 to be placed at this spot, to facilitate the rotation of lid 214, during opening and closing assembly 210.

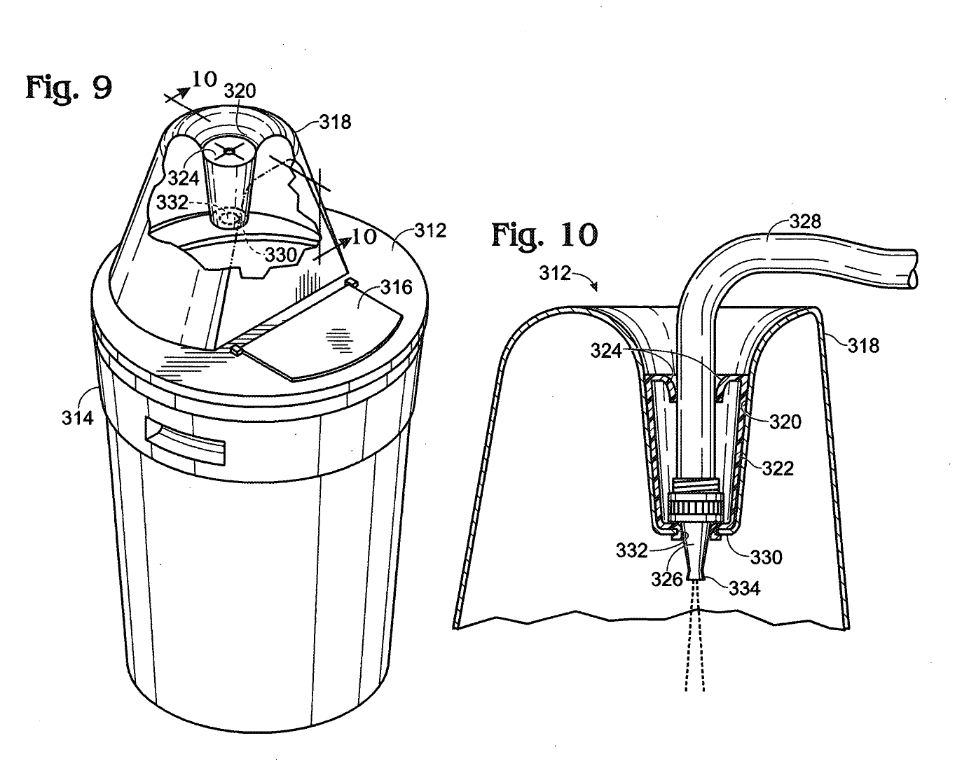

Referring to FIGS. 9 and 10, an alternative preferred embodiment of a pet waste disposal system 310 includes an interlocking lid 312 and a container 314. Lid 312 includes a hinged flap 316, permitting the introduction of pet waste, and an upwardly rising partial dome 318, defining an indent 320. A rubber or plastic boot 322, set into indent 320, defines a set of four flaps 324, which yield to permit entry of a nozzle 326 and hose 328 (FIG. 10). An inwardly extending rim 330, of indent 320 covered with the boot 322, defines an aperture 332, through which a distal end 334 of the nozzle 326 extends, with the wide base portion of the nozzle 326 supported by the rim 330. The boot 322 is preferably made of a rubber-like material having a high coefficient of friction. In one preferred embodiment the boot 322 is made with enough elasticity that it permits the nozzle 326 to move while water is streaming through it.

The uses and advantages of system 310 should now be apparent to skilled person. Hinged flap 316 may be quickly opened and shut to permit placing waste into the container 314 without exposing the person doing so to as great an exposure to the container contents as might be unavoidable with a system in which the entire lid must be removed. In addition, a person who uses who generally keeps his garden hose capped with a nozzle, can simply take the nozzle-bearing hose 328 and introduce it into boot 320, without the need to rotate a hose end to attach it to a threaded coupler. As a result an entire waste watering operation may be performed in a period of time on the order of one and half minutes, with the nozzle-bearing hose 328 quickly inserted into boot 320, the water turned on and the off, and the hose 328 quickly pulled out again.

Assembly 10, 110, 210 and 310 are all preferably made of a tough polymeric material, such as that currently used for polymeric or plastic trash cans.

Although the preceding description contains many specificities, these should not be construed as limiting the scope of the invention but as merely providing illustrations of some of the presently preferred embodiments of this invention. For example, the lid retention means can be a chain, a rope, a locking mechanism in the hinge, etc.; the material of the invention can be plastic, metal, or some other lightweight rigid material; the hose attachment means can be either screw on or clamp on; the body can have other shapes, such as round, square, oval, triangular, etc.; the length and diameter of the body can vary significantly; the invention can operate in either the open or closed position, etc. Thus the scope of the invention should be determined by the append claims and their legal equivalents, rather than by the examples given.

1. A method of disposing and treating a biodegradable material that produces an unpleasant odor when it is watered and stirred, comprising:
(a) providing an assembly having:
(i) a container;
(ii) a standard garden hose in fluid communication with a faucet;
(iii) a pressure nozzle in fluid communication with said standard garden hose; and
(iv) a nozzle-retaining apparatus oriented so that said water expressed from said nozzle is directed into said container so as to produce a stirring motion within said container;
(b) placing said biodegradable material into said container; and
(c) actuating said faucet to cause water to flow through said hose and out said nozzle, thereby watering and stirring said biodegradable material while remaining at a distance far enough away from said container to avoid the unpleasant odor that is emitted from said container by virtue of said watering and stirring.

2. The method of claim 1, wherein said nozzle is removeably retained by said nozzle-retaining apparatus, thereby permitting said nozzle to be removed from said assembly between instances of assembly use.

3. The method of claim 2, wherein said nozzle is retaining apparatus is in the form of a boot adapted to quickly accept and retain a nozzle.

4. The method of claim 3, wherein said boot includes resilient flaps, which part to accept a nozzle.

5. The method of claim 3, wherein said boot includes a nozzle through-hole, made of resiliently deformable material for accepting said nozzle.

6. The method of claim 3, wherein said boot is made of a rubber-like material, to help retain said nozzle through friction.

7. The method of claim 1 wherein said nozzle-retaining apparatus is adjustable so that said nozzle may be moved into position for storage purposes between instances of nozzle use.

8. The method of claim 1 wherein said container is a tube partially buried in the ground and being open at its top and bottom.

9. The method of claim 1, wherein said tube is a circular tube.

10. The method of claim 1, wherein said assembly further includes a tightly fitting lid for said container.

11. The method of claim 1, wherein said assembly further includes at least one additional pressure nozzle, in fluid communication with said fitting.

12. The method of claim 1 wherein said nozzle retaining apparatus retains said nozzle at a fixed angle.

13. The method of claim 1 wherein said nozzle retaining apparatus is adapted to cause said nozzle to move during use, thereby facilitating the stirring action.

14. An assembly adapted to facilitate the disposing and treating of a biodegradable material that produces an unpleasant odor when it is watered and stirred, comprising:
(a) a container;
(b) a fitting for accepting and retaining the insertive coupler of a standard garden hose;
(c) a pressure nozzle in fluid communication with said fitting for receiving water from said fitting and expressing said water under pressure; and
(d) a nozzle retaining apparatus oriented so that said water expressed from said nozzle is directed into said container so as to produce a stirring motion within said container.

15. The assembly of claim 14, wherein said nozzle is removeably retained by said nozzle-retaining apparatus, thereby permitting said nozzle to be removed from said assembly between instances of assembly use.

16. The assembly of claim 15, wherein said nozzle retaining apparatus is in the form of a boot adapted to quickly accept and retain a nozzle.

17. The assembly of claim 14, wherein said nozzle retaining apparatus is adjustable so that said nozzle may be moved into position for storage purposes between instances of nozzle use.

18. The assembly of claim 14, wherein said container is a tube partially buried in the ground and being open at its top and bottom.

19. The assembly of claim 14, wherein said tube is a circular tube.

20. The assembly of claim 14, further including a tightly fitting lid for said container.

21. The assembly of claim 14, further including at least one additional pressure nozzle, in fluid communication with said fitting.

22. The assembly of claim 14, wherein said nozzle retaining apparatus retains said nozzle at a fixed angle.

23. A method of disposing and treating a biodegradable material that produces an unpleasant odor when it is watered and stirred, comprising:
(a) providing an assembly having:
(i) a container;
(ii) a nozzle-retaining apparatus oriented so that said water expressed from said nozzle is directed into said container so as to produce a stirring motion within said container;
(b) providing a hose having one end that is nozzle-bearing and another end that is connected to a faucet;
(c) placing said nozzle bearing end of said hose into said nozzle-retaining apparatus;
(d) placing said biodegradable material into said container; and
(e) actuating said faucet to cause water to flow through said hose and out said nozzle, thereby watering and stirring said biodegradable material while remaining at a distance far enough away from said container to avoid the unpleasant odor that is emitted from said container by virtue of said watering and stirring.

24. The method of claim 21 wherein said assembly further includes a hinged flap adapted to permit introduction of material into said container.
